(19) United States
(12) Patent Application Publication
(10) Pub. No.: US 2002/0140735 A1
(43) Pub. Date: Oct. 3, 2002

(54) Interactive digital environment structured in the format of a paper publication

(76) Inventor: Luca Bosurgi, London (GB)

Correspondence Address: Rashida A. Karmali Esq., 99 Wall Street, New York, NY, 10005, US

(21) Appl. No.: 09/823,358

(22) Filed: Mar. 30, 2001

(51) Int. Cl. G06F 3/00

(52) U.S. Cl. 345/776; 345/854

(57) ABSTRACT

The present invention relates to software tools for facilitating the management and navigation of World Wide Web sites, interactive digital environments, and other types of data systems by structuring them like a paper publication instead of using hyperlinks to facilitate user navigation.

### FIELD OF INVENTION

The present invention relates to software tools for facilitating the management and navigation of World Wide Web sites, interactive digital environments, and other types of data systems by structuring them like a paper publication instead of using hyperlinks to facilitate user navigation.

### BACKGROUND OF THE INVENTION

The Task of managing Web site content and maintaining Web site effectiveness or lure is becoming increasingly difficult with the popularity and complexity of Internet and Intranet applications. Business managers and Webmasters are faced with a variety of tasks including, for example, the identification and repair of broken links, the monitoring of large volumes of changing Website content or management of congested links. These problems become troublesome when users begin to lose interest because of the constrained mode of navigating through the hyperlinks. The problem becomes magnified for companies that rely on their Web sites to provide critical information and services to customers and business partners.

The present invention addresses these and other limitations in existing Web sites and technologies.

### DESCRIPTION OF THE INVENTION

In accordance with the present invention, an innovative system is provided which includes a variety of features for facilitating the management and use of web sites and other interactive digital environments. In the preferred embodiment, a web site is built like a paper publication such that, even though the web site, it may be read with the ease associated with reading a magazine. In other words, the present invention provides a system in which each screen represents a double page spread and the user is able to turn the pages, i.e., flick, in the same way as with a traditional paper publication.

The present invention provides a system wherein each page allows a combination of text, sound, motion, images or video in a multimedia format, thereby upgrading that images and text to an entertainment and interactive experience for the user. The system therefore offers the user interactive articles as well as fun, interactive and non-intrusive advertising.

The present invention further provides a system having a format of a paper publication, a format heretofore not used or considered suitable for web sites. Such a format provides the user with a familiar tool of a paper publication.

It also encourages interaction and enthusiasm to discover, while the multimedia aspect engages and rewards the attention of the user. The invention further provides advertisers with a totally innovative, authentic, entertaining and unobtrusive media.

One particular embodiment of the present invention is called “F magazine”. F magazine is a system that is user friendly, having a full contents page similar to an index. This page allows the user to navigate in a non-linear movement through the content. The invention thus provides an easy-to-use navigation system and includes numbered pages, thereby representing the next step toward simplicity and an providing an instinctive and efficient approach to the net and its associated information and education portals.

The present invention further includes an application of paper publication format in e-ecommerce (entertainment e-commerce). Traditional e-commerce sites generate graphical maps which tend to be difficult to navigate and fail to convey much of the information needed by the Webuser. The present invention integrates into its editorial the functionability of interactive mail order. This feature gives the user the experience of a beautiful magazine with an instant and simple facility to buy featured products. The system places the product throughout the content and creates the right environment to stimulate the desire and imagination of the customer.

The present invention provides a method by which F magazine acts as an intermediary, collecting orders for reputable e-commerce companies and for brands organized to sell online.

The various features of the invention will now be described in greater detail with reference to the drawings of a preferred software package for F magazine, its screen displays and various related components.

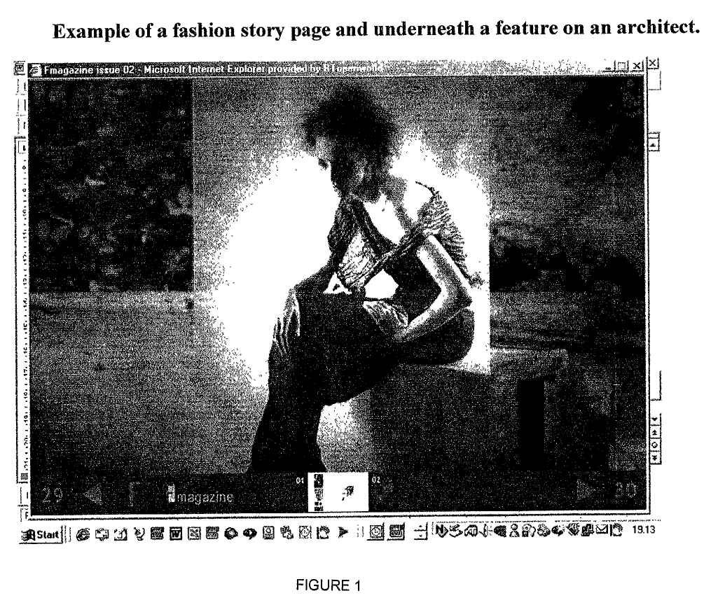

FIG. 1 shows an example of a fashion story page typical of the double page format of F Magazine. It is clear and eye catching, and with the flick of a page, the article begins. This article, as well as others can be jumped to from the table of contents.

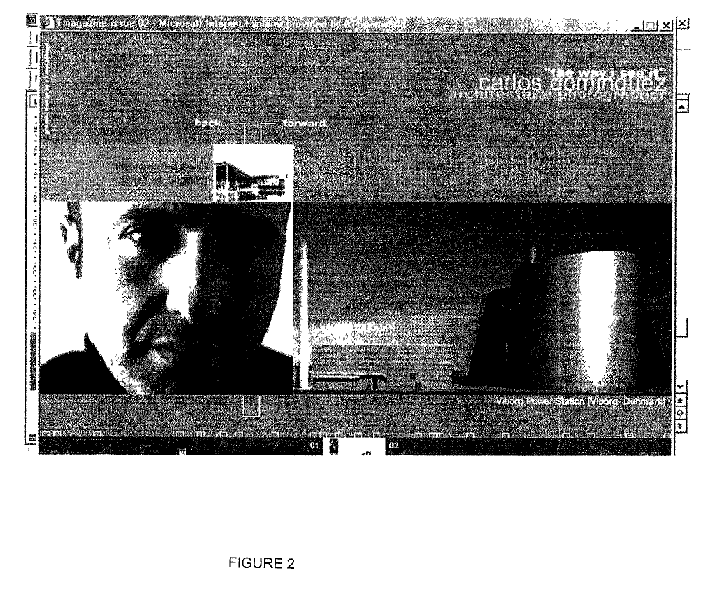

FIG. 2 is another example of a typical “magazine” page, complete with exciting glossy pictures, text, and possible audio or video. The article becomes an interactive experience, as opposed to waiting for links to connect as with other informational sites.

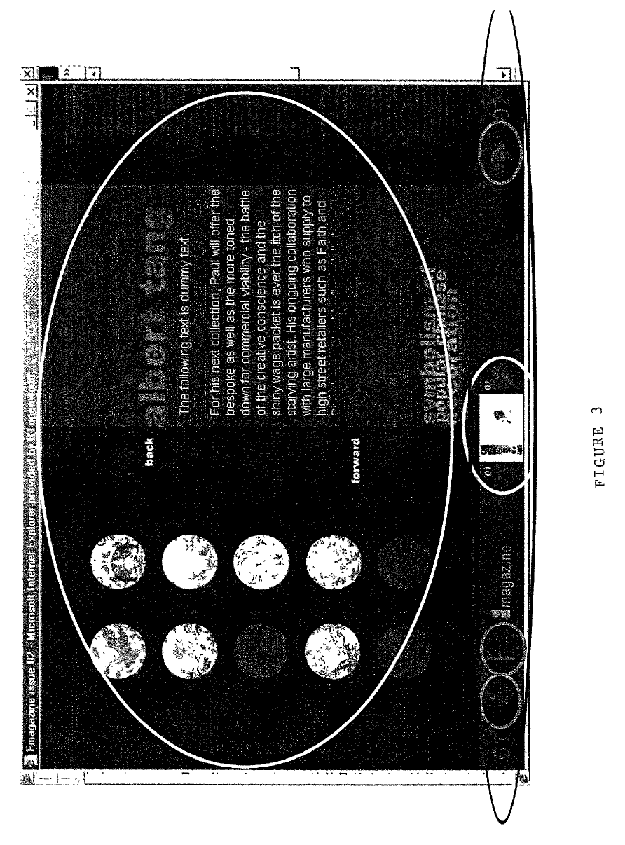

FIG. 3 is an outline of the format and user friendly capabilities of F Magazine. The large upper circle represents the main screen as a double page also providing interactive multimedia features. The widest lower circle contains all of the navigational tools provided to ease the reader's way around the magazine. The two outermost circles, containing triangles are the means for the user to “flip” the page. The circle around the “F” (bottom left) is a toggle bar to other services provided by the site. The middle circle on the bottom is a mini-book of thumbnails, giving the user the option to jump to anywhere in the magazine, as opposed to page-by-page.

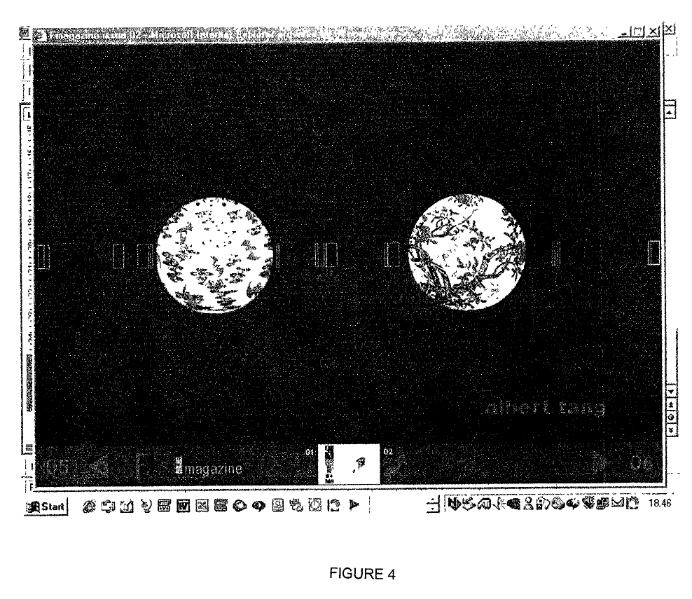

FIG. 4 shows the initial form of an interactive (dummy) article. The magazine is showing a collection of vases from the previous figure.

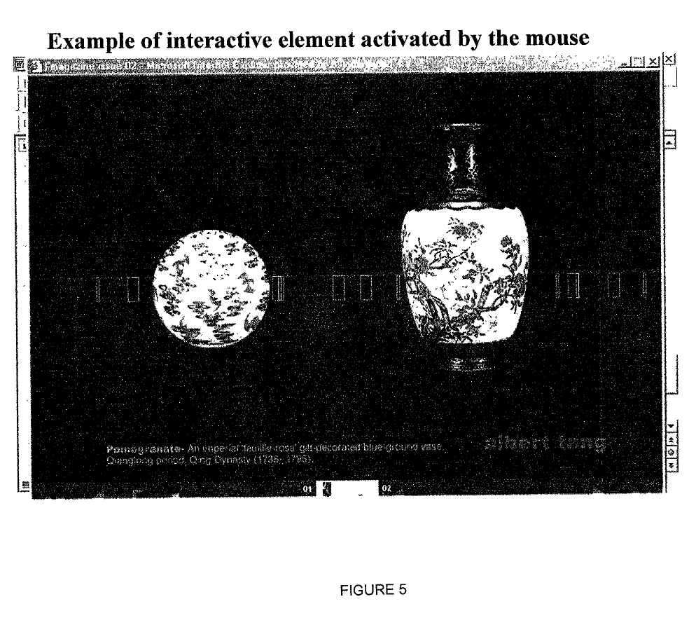

FIG. 5 is the follow up to the previous figure showing how the picture is expanded from a circular pattern to a full vase by merely placing the mouse over the existing picture. This interactive multimedia design allows the reader to read about, then see the object without having to link to another page.

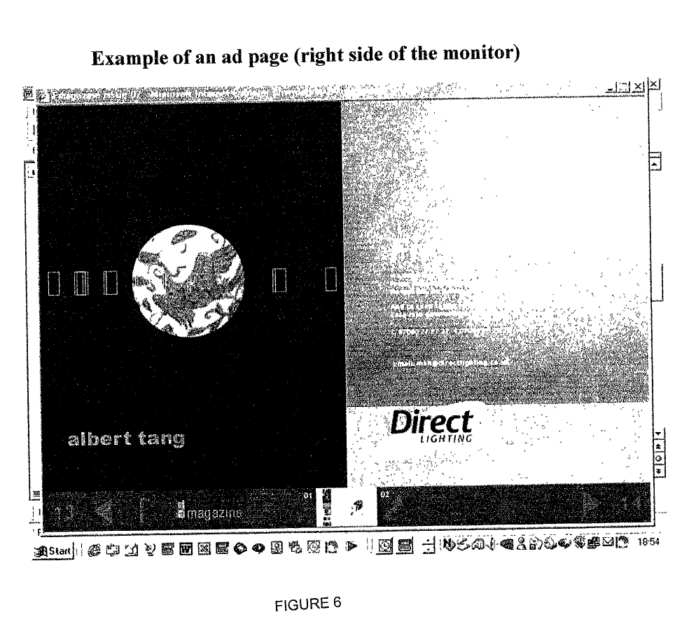

FIG. 6 shows how advertisements are integrated into the magazine in a non-offensive fashion. On the right-hand side of the screen an advertisement is shown with information about sales so the product can be bought directly instead of linking to other web-sites and losing the current page. It can also be easily flipped over to the next page, instead of having to close a window that the user did not open.

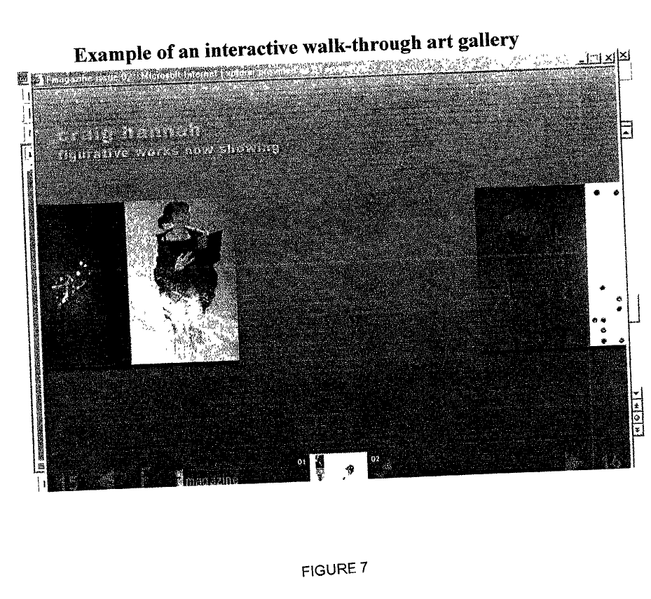

FIG. 7 gives an example of another type of interactive article, this being a walk-through art gallery. The reader is able to browse through the exhibits that they want to see by placing the mouse over pictures to expand them, then clicking them for a more extensive view. This format is fun, new, and gives the user the freedom to jump from exhibit to exhibit without waiting.

While the above description contains many specifics, these specifics should not be construed as limitations on the scope of the invention, but merely as exemplification of preferred embodiments thereof. Those skilled in the art will envision many other possible variations that are within the scope and spirit of the invention as defined by the claims appended hereto.

What is claimed is:

1. A system for an interactive digital environment, structured in the format of a paper publication, said system comprising:
an interactive component including a plurality of multimedia feature pages,
a navigational component which has an executable code for flipping the pages over a network connection, and an application which allows a user to navigate to any page instinctively.

2. The system according to claim 1, further comprising an e-commerce component, said component facilitating for products placement, illustration and purchase of products displayed over the network connection.
